(19) United States
(12) Patent Application Publication
(10) Pub. No.: US 2024/0172724 A1
(43) Pub. Date: May 30, 2024

(54) CANINE PROTECTIVE BOOT

(71) Applicant: Jo Won Seuk, Whispering Pines, NC (US)

(72) Inventor: Jo Won Seuk, Whispering Pines, NC (US)

(21) Appl. No.: 18/070,612

(22) Filed: Nov. 29, 2022

(51) Int. Cl. A01K 13/00

(52) U.S. Cl. CPC A01K 13/007; A01K 2227/10

(57) ABSTRACT

The protective boots are wrap style boots that cover and protective the canine's paws and upper legs and include thin internal stiffeners that prevent the boot from sagging down the dog's leg. The stiffeners are a thin narrow strip of polymeric plastic. Each boot has a central stay stiffener and a pair of side stiffeners. The central stay stiffener covers the sole of the boot and extends up the length of the boot's back stay reinforcing the boot's sole and back stay. The side stiffeners sandwich and reinforce the boot's upper around the canine's leg. The protective boot is secured about the canine leg by laces and a pair of straps, which also helps prevent the boot from sliding or sagging over the canine wrist.

This invention relates to protective footwear for canines, and in particular, a canine protective boot having internal stiffeners to prevent the boot from sagging down around the canine paws.

### BACKGROUND AND SUMMARY OF THE INVENTION

Canine footwear (“boots”) has been developed to mitigate the discomfort that dogs may experience when standing, walking, or running on harsh terrain, such as hot pavement, snow or rough and jagged surfaces and to protect the dog's paws and legs from cuts, burns and other injuries. Generally, canine boots take the form of either a tube sock style covering that slips over the dog's paw and wrist or a wrap style covering that wraps over and around the paw and wrist. In both styles of footwear, straps and laces are used to secure the covering to the dog.

It is inherently difficult to configure a boot to accommodate different dog breeds, as well as different sized dogs within any particular breed. One particular issue with both tube-sock and wrap style canine boots is that the boots tend to slide down on the dog's leg during vigorous activity, much like a loose sock tends to sag down around a human's ankle. When the footwear sags down the dog's leg, the dog loses the protective benefit of the footwear, and the bunching of the boot around the paw and wrist encumber the dog's movement. Simply applying more force to the straps and lacing about the dog's leg to keep the boot in place is often inadequate due to the anatomy of the canine paw and leg.

The protective boots of this invention are wrap style boots that cover and protect the canine's paws and upper legs and include thin internal stiffeners that prevent the boot from sagging down the dog's leg. The stiffeners are a thin narrow strip of polymeric plastic, approximately 1 mm in thickness. Each boot has a central stay stiffener and a pair of side stiffeners. The central stay stiffener covers the sole of the boot and extends up the length of the boot's back stay reinforcing the boot's sole and back stay. The side stiffeners sandwich and reinforce the boot's upper around the canine's leg. The protective boot is secured about the canine leg by laces and a pair of straps, which also helps prevent the boot from sliding or sagging over the canine wrist.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a front perspective view of an embodiment of the canine boot for the front legs;

FIG. 2 is a plan view of the covering wrap of the canine boot of FIG. 1;

FIG. 3 is a partial fragmented plan view of the covering wrap of FIG. 2;

FIG. 4 is another partial fragmented plan view of the covering wrap of FIG. 2;

FIG. 5 is a partial exploded view of the covering wrap of FIG. 2;

FIG. 6 is a side sectional view of the covering wrap of FIG. 2;

FIG. 7 is a side view of the canine boot of FIG. 1 donned by a canine; and

FIG. 8 is side view of a second canine boot for the rear legs donned by a canine.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

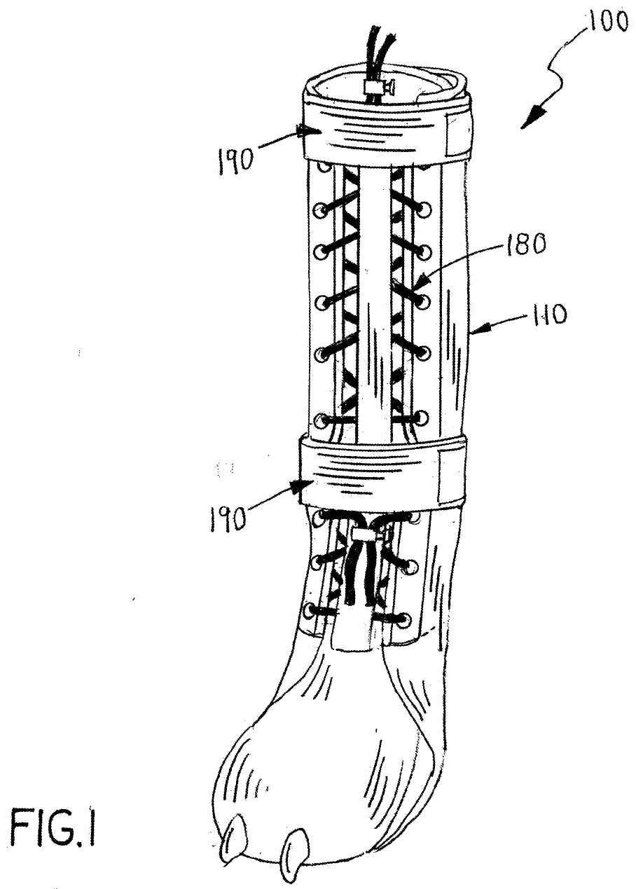

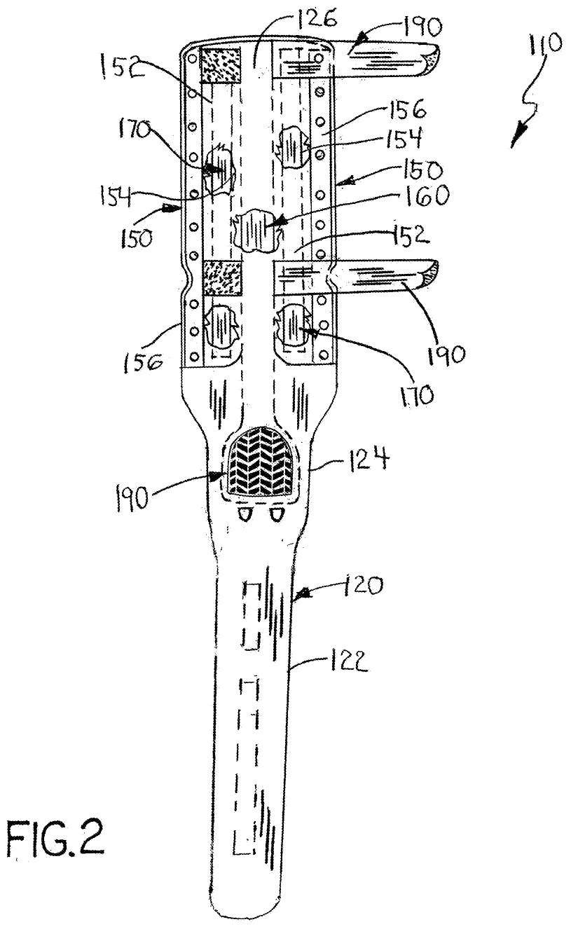

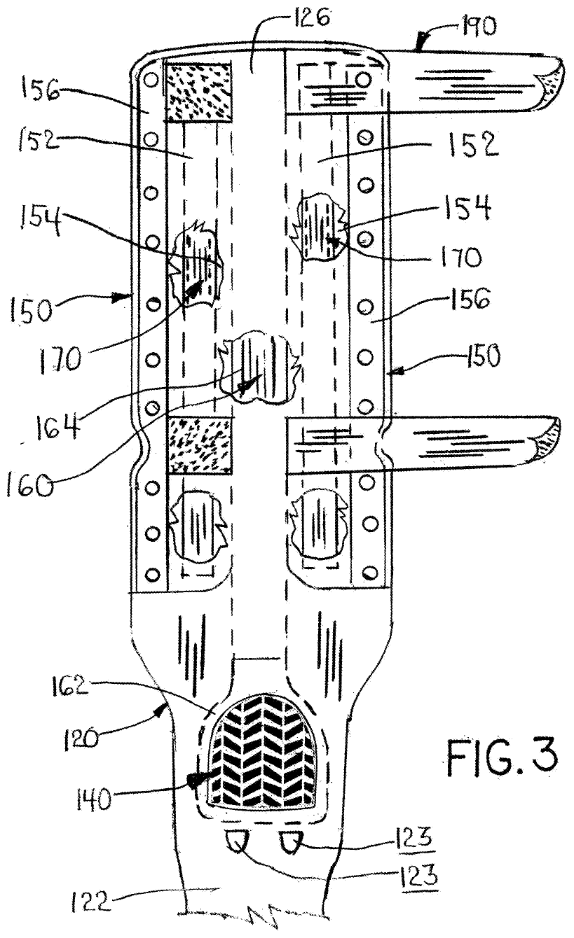

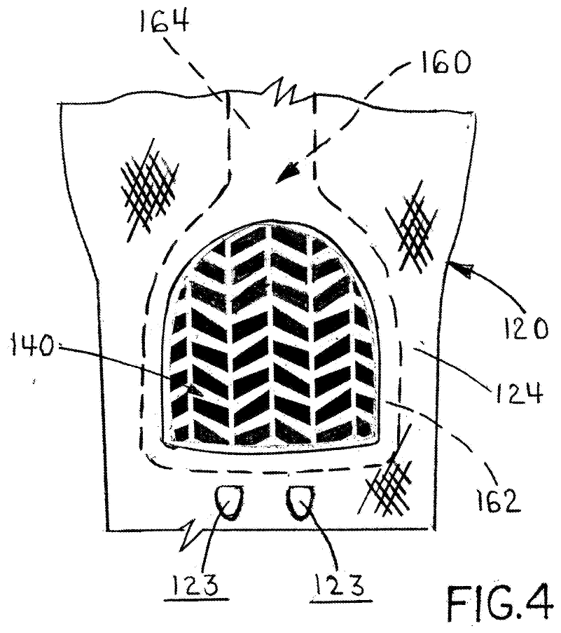

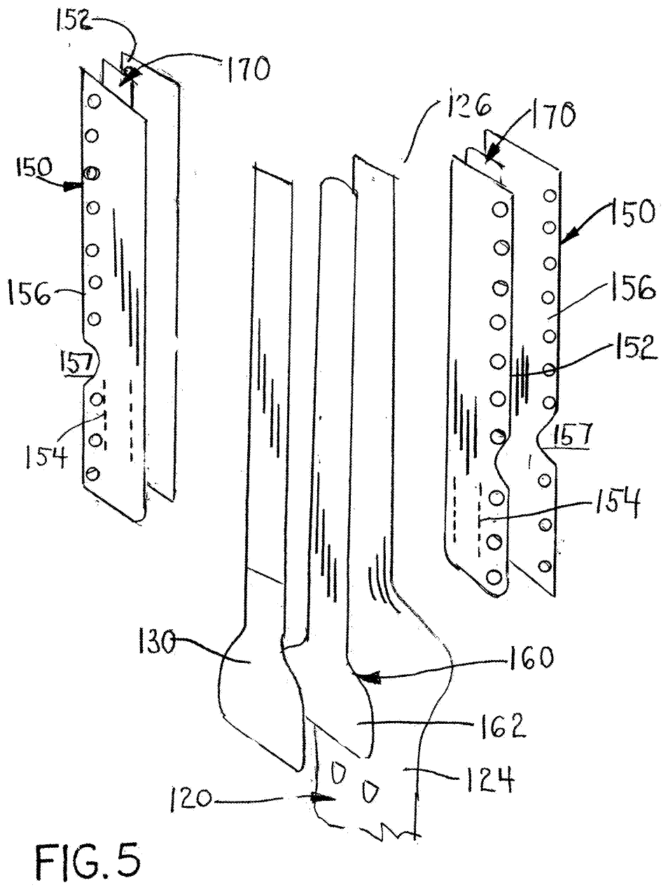

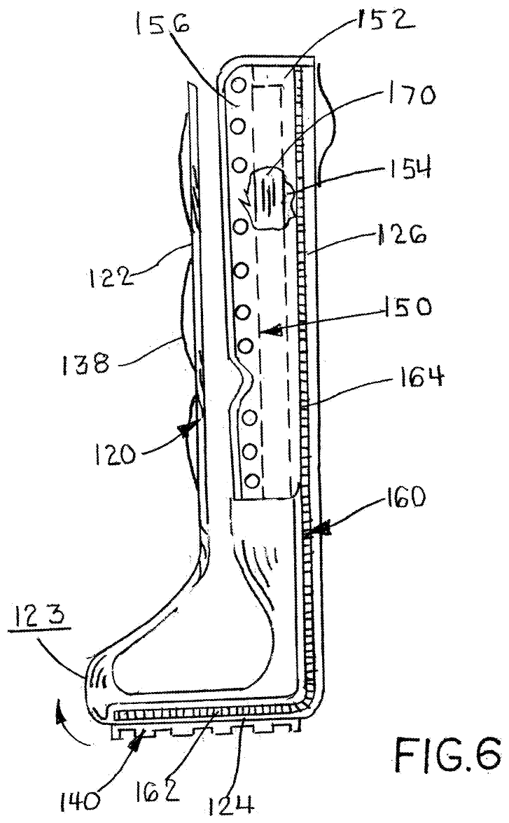

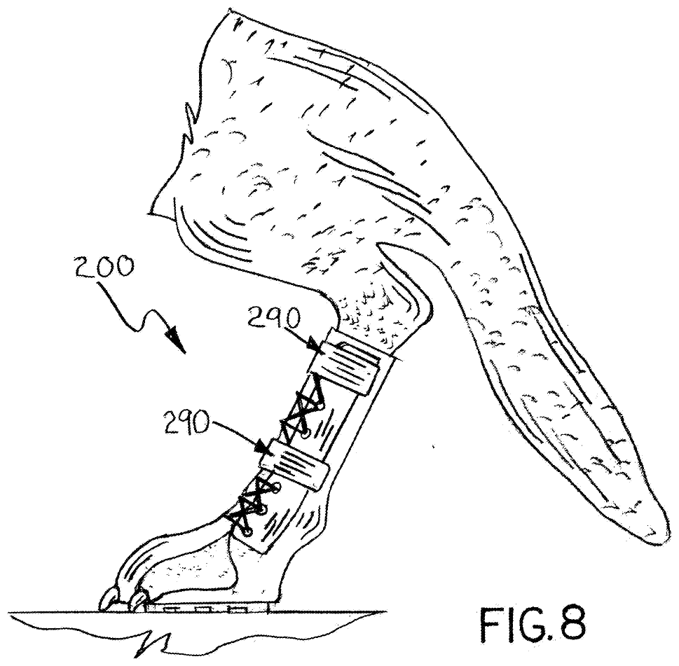

The drawings illustrate two exemplary embodiments of the protective canine boot of this invention. FIGS. 1-7 illustrate an exemplary embodiment of a protective canine boot for the canine front legs, which are designated generally as reference numeral 100. FIG. 8 illustrates an exemplary embodiment of a protective boot for the hind legs of a canine, designated generally as reference numeral 200. The protective boots are wrap style boots that cover and protective the canine's paws and upper legs and include thin internal stiffeners sewn into the boot's upper to prevent the boot from sagging down the dog's leg.

Typically, protective canine boots 100 and 200 are used in pairs for each of the left and right legs. Both boots have identical construction and configuration and differ only in length to accommodate the anatomy of the canine's front and hind legs. The protective boots may also be sized for different canine breeds. Both the protective canine boots 100 and 200 cover the canine paws and legs and protection for the canine from bruising, cuts, and other injury. When donned, the protectively boots wrap over and around the canine's paw and leg forming a pliable sole, “toebox” (paw box), an upper and tongue.

Protective canine boots 100 and 200 are constructed from various fabrics, selected for durablity, tear and water resistance and pliability. The fabrics are joined together using conventional methods and techniques, such as adhesives, heat welding, sewing, and the like. Where various components of the protective boots are preferably sewn together, the sewing is done using nylon or Dacron thread using well known techniques in the sewing arts. Other components may be bonded together using conventional fabric adhesives, such as adhesive style #3206 manufactured by Bemis Associates of Shirley, Mass.

Referring now to FIGS. 1-7, protective boot 100 is intended for use on a canine's front legs. Protective boot 100 is formed by an elongated covering wrap 110 that wraps back to front over and around a canine paw and upper leg and is secured by laces 180 and a pair of straps 190.

Covering wrap 110 includes a base cover section 120 of outer material cut from a durable, tear and wear resistance fabric, such as AX Suede, available from AX® Materials, a division of Matmarket LLC of Portsmouth, New Hampshire. As shown, base cover section 120 is cut and configured as an elongated body forming an integral tongue 122 a sole 124 and a narrow back stay 126. Tongue 122 extends forward from sole 124 and is configured to wrap over top of the canine paw and overlie the front of the canine lower leg. When folded over sole 124, tongue 122 forms a “toe box” for receiving the canine paw. Tongue 122 has two claw slits 123 that receive the canine's two middle claws. Claw slits 123 assist in preventing the canine paw from shifting and twisting within protective boot 100. Covering wrap 120 also includes a sole and back stay liner 130.

A paw pad 140 is bonded to the bottom sole 124. Paw pad 140 is generally a flat pliable pad of protective silicon or natural rubber with a tread pattern formed on its exterior surface. Paw pad 140 provides traction and cushion to protective boot 100, as well as a measure of puncture resistance.

A pair of wrap sides 150 are sewn to outer fabric 120 on opposed sides of back stay 126 along sole 124 to form the upper of protective boot 100. Each wrap side 150 has an outer panel 152 and an inner liner 154. Outer panels are generally cut from sheets of nylon fabric, such as Cordura® available from INV Performance Materials, LLC of Wichita Kansas. Liners 154 are generally cut from sheets of nylon fabric, such as Lycra® available from The LYCRA Company LLC. of Wilmington Delaware. Wrap sides 150 terminate along one edge in eyelet stays 156 and have an edge notch 155 to aid in articulation of the upper at the canine's wrist. The interior surface of liner 154 has a silicone printing to help maintain the upper in place on the canine's leg.

Cover wrap 110 has a central stay stiffener 160 and a pair of side stiffeners 170. Central stiffener 160 and side stiffeners 170 are thin strips of polymer plastic, approximated 1 mm in thickness. Central stiffener 160 is configured as having an integral semi-circular sole end 162 and a long narrow rectangular back stay end 164. Central stiffener 160 is sewn between base cover 120 and an inner liner 130 with sole end 162 positioned over sole 124 and extending up the length of back stay 126. Liner 130 is configured to cover central stiffener 160 and also has a silicone printing to help maintain the upper in place on the canine's leg. Side stiffeners 160 are sewn between outer panel 132 and liner 134 and extend nearly the entire length of wrap sides 130. Central stiffener 160 provides a semi rigid base for sole 122 and vertical support for back stray 124. Side stiffeners 170 sandwich and reinforce the upper around the canine's leg.

As shown, laces 180 draw wrap sides 150 together. Laces 180 are typically conventional nylon shoe laces or lengths of paracord. Straps 190 secure the upper of protective boot 100 around the canine's legs. Straps 190 are lengths of nylon webbing. One end of straps 190 is sewn directly to one of the wrap sides 140 and the opposite end is detachably secured to the other wrap side 140 by mating patches of hook and loop fasteners (not shown) affixed to the wrap side and strap. In alternative embodiments, other conventional fastening methods may be employed, such as snaps, buckles and the like.

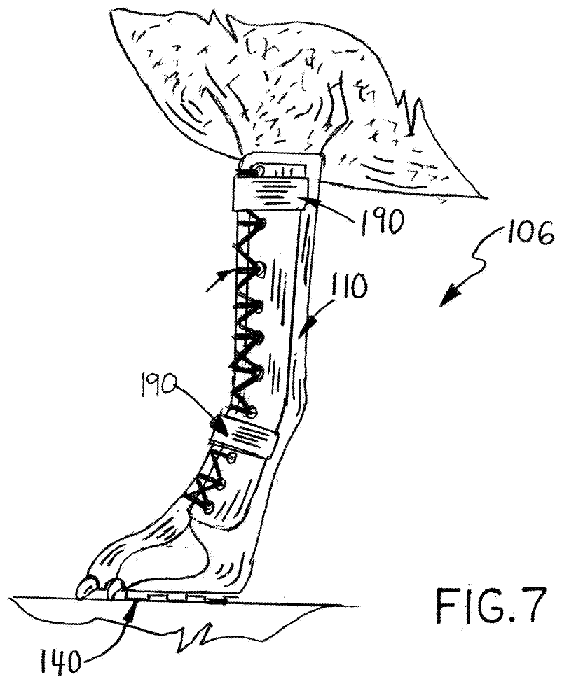

When donned (FIG. 7), the canine's leg is wrapped in cover wrap 110 with the paw centered over sole 124. Tongue 122 is wrapped over the paw and up the leg and wrap sides 150 are wrapped around the leg and secured by laces 180 and straps 190. The middle claws extend through claw slits 125 with the canine's lateral claws extending from the open toe box. The pliable but semi-rigid stiffeners 160 and 170 extend vertically upward along the sides and back of the canine's leg and prevent the upper of the protective canine boot 100 from sagging down around the canine paw. One strap 180 extends around the pastern just below the carpus (wrist) and the other strap 180 extends around the canine forearm below the elbow.

FIG. 8 illustrates the hind leg protective boot 200. Boot 200 is identical in construction and function as front boot 100. As shown, front boot 100 has a slightly longer upper than rear boot 200. When donned, both straps 270 wrap laterally around the pastern with the upper most strap 270 positioned just below the hocks.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A protective canine boot wearable on and over the paw and legs of a canine comprising:
an elongated covering wrap adapted to wrap back to front over and around a paw and upper leg of the canine, the covering wrap includes an integrated elongate tongue, a sole, and upper, the upper is formed by a narrow back stay extending from the sole and a pair of side panels joined on opposed sides of the back stay,
the covering wrap further includes a plurality of stiffening elements affixed within the upper to prevent the covering wrap from sagging down the upper leg around the paw when the canine boot is donned.

2. The canine boot of claim 1 wherein each of the plurality of stiffening elements is a thin narrow length of polymer material.

3. The canine boot of claim 2 wherein, the plurality of stiffening elements includes a central stiffener affixed longitudinally to the upper.

4. The canine boot of claim 3 wherein the central stiffener is affixed to the sole and back stay.

5. The canine boot of claim 3 wherein the central stiffener is sewn between an outer covering material and an inner liner material.

6. The canine boot of claim 2 wherein, the plurality of stiffening elements includes a side stiffener affixed within each of the opposed sides panels.

7. The canine boot of claim 6 wherein the side stiffener of each of the side panels is sewn between an outer covering material and an inner liner material.

8. The canine boot of claim 1 wherein the covering wrap includes a pad affixed to the exterior surface of the sole.

9. The canine boot of claim 1 also comprising laces woven through the covering wrap to secure the covering wrap about the upper leg of the canine; and a strap affixed to the covering wrap to further secure the covering wrap to the upper leg of the canine.

10. The canine boot of claim 9 wherein the laces are interwoven between the opposed side panels.

11. The canine boot of claim 9 wherein the strap is affixed to the upper so that the strap is located to extend around the pastern just below the carpus of the canine when the boot is donned.
